(19) United States
(12) Patent Application Publication
(10) Pub. No.: US 2020/0068869 A1
(43) Pub. Date: Mar. 5, 2020

(54) Apparatus For Managing Agricultural Overspray

(71) Applicant: Croplands Equipment Pty Ltd, Dry Creek (AU)

(72) Inventors: Leslie Roy Bollenhagen, Dry Creek (AU); David Manktelow, Napier (NZ)

(73) Assignee: Croplands Equipment Pty Ltd, Dry Creek (AU)

(21) Appl. No.: 16/467,942

(22) PCT Filed: Jun. 29, 2017
(86) PCT No.: PCT/AU2017/050666

§ 371 Date: Jun. 7, 2019

(30) Foreign Application Priority Data
Dec. 14, 2016 (AU) 2016905166

(51) Int. Cl. A01M 7/00

(52) U.S. Cl. CPC A01M 7/0067; A01M 7/0075

(57) ABSTRACT

A mobile agricultural spray apparatus, the spray apparatus including at least one spray nozzle arranged to be on one side of a crop during spraying and an overspray collector arranged to be on the opposite side of the crop during spraying such that the overspray collector can capture overspray from the spray nozzle during operation, wherein the overspray collector includes: at least two curtains, the curtains including at least one pervious and flexible front curtain and an impervious rear curtain; an overspray space between the pervious front curtain and the impervious rear curtain; and an overspray chamber in fluid communication with at least the overspray space for collection of overspray captured by the overspray collector.

### RELATED APPLICATION

This application claims convention priority from Australian provisional patent application 2016905166 filed on 14 Dec. 2016. The contents of that application are incorporated herein by reference.

### FIELD OF THE INVENTION

The present invention relates to agricultural apparatus for spraying crops, particularly mobile apparatus designed to move along a line of crops for the purpose of spraying, for example, liquid insecticides, herbicides, fungicides and fertilisers onto those crops. The present invention relates particularly to managing overspray, overspray being the excess spray not caught by a crop canopy during spraying, which is then normally lost to the ground.

### BACKGROUND OF THE INVENTION

Agricultural apparatus for spraying crops is now quite mechanically sophisticated and powerful. The spraying systems used are able to deliver targeted volumes of liquid atomised into spray droplets by one or more nozzles with various forms and quantities of air assistance depending upon the crops, the liquid, and the environmental and operational requirements of the relevant region.

Agricultural chemicals are by nature toxic in the environment and are subject to legislative and physical controls to minimise unnecessary environmental loading. However, spraying operations always result in some chemical losses. These losses are greatest on dormant and early season crop canopies where it is common to fail to deposit between 50-95% of the applied spray onto the target, principally because most is lost as overspray beyond the target through canopy gaps. Agrichemical use efficiency and environmental protection can be improved by increasing spray retention on target and by capturing and reusing overspray.

U.S. Pat. No. 6,302,332 to Panneton et al provides a useful summary of previous attempts of dealing with overspray, and itself provides one solution. Panneton et al describes several prior art attempts at providing suction hoods on the opposing side of a crop, opposite to spray nozzles, to force the capture of overspray. Panneton et al also describes prior art attempts at constructing reasonably complex and large tunnel systems to better surround and encapsulate crops, again with the use of suction systems to capture overspray or with the use of complex air circulation systems to redirect overspray.

Panneton et al discusses problems with these systems and then mentions the use of passive systems (that do not rely on suction or air circulation), including one system that uses an absorbent fibrous material to capture overspray. Panneton et al then describes its own inventive system as a system that relies on a passive collection system in the form of a separator panel having rigid aluminium sheets, arranged at an angle to the flow direction of the overspray, and perforated and profiled to allow for air and entrained droplets to pass completely through without deviation.

As can be seen, the apparatus of Panneton et al is itself large and complex, and by utilising rigid panels for droplet separation gives rise to a large degree of bounce-back of droplets that hit the rigid aluminium panels. Furthermore, any overspray that does not hit the rigid aluminium panels simply moves completely through the apparatus to be forced by a blower fan up into an overhead duct and recycled back to the sprayer.

It is an aim of the present invention to provide a mobile agricultural spray apparatus that is simple in construction and that does not require suction or a blower, on the opposite side of a crop to spray nozzles, in order to capture and recycle overspray from the spray nozzles.

Before turning to a summary of the solution provided by the present invention, it should be appreciated that reference to any prior art in this specification is not, and should not be taken as, an acknowledgment or any form of suggestion that this prior art forms part of the common general knowledge in any country. It should also be appreciated that the reference to “crop” throughout this specification is not intended to be a limitation of the type of plant, bush or tree that the apparatus of this invention might be used with.

### SUMMARY OF THE INVENTION

The present invention provides a mobile agricultural spray apparatus, the spray apparatus including at least one spray nozzle arranged to be on one side of a crop during spraying and an overspray collector arranged to be on the opposite side of the crop during spraying such that the overspray collector can capture overspray from the spray nozzle during operation, wherein the overspray collector includes:

at least two curtains, the curtains including at least one pervious and flexible front curtain and an impervious rear curtain;

an overspray space between the pervious front curtain and the impervious rear curtain; and

an overspray chamber in fluid communication with at least the overspray space for collection of overspray captured by the overspray collector.

In a preferred form of the present invention, the rear curtain is also a flexible curtain.

The flexible curtain(s) of the overspray collector, in conjunction with the overspray space, ideally function in combination to dampen the pressure and speed (and thus the energy) of the droplets of the overspray, minimising or entirely reducing spray bounce-back and/or spray droplet shatter from the overspray collector, and to maximise the capture of overspray that reaches the collector.

The pervious nature of the front curtain, being the curtain closest to the spray nozzle, is preferably such as to permit the passage of both air and liquid droplets (and small solid particles if the spray includes solid particles) through the front curtain into the overspray space, but yet minimise the return of air and liquid droplets back through the front curtain after impacting the impervious rear curtain and circulating within the overspray space.

It is the combination of the flexible nature of the front curtain (and of the front and rear curtains, if both are flexible), the size of the overspray space, the size and configurations of the apertures of the pervious material, the thickness of the pervious material, the spray pressure, the liquid droplet size, the liquid type, and the contact angle of the spray with the front curtain, that may be considered in order to minimise spray bounce-back and maximise overspray collection.

In practice, it will be understood that liquid from the overspray will be captured on each of the outside and inside surfaces of the front curtain (not all droplets will pass through the pervious front curtain), the inside surface of the rear curtain, and within the overspray space itself, with ideally all of that captured liquid falling or flowing by way of gravity downwardly to be collected by the overspray chamber of the collector.

Additionally, the pervious front curtain can serve to act as a primary filter for any plant trash (such as twigs, sticks and leaves) knocked off the crop by the sprayer, which will tend to be washed down the outside surface of the front curtain (or may be wiped from the front surface, either manually or by a separate wiping device) to be collected and removed or to be disposed onto the ground.

The flexible curtain(s) of the overspray collector are preferably formed from a non-rigid material that is pliant and supple. Suitable materials are preferably chemically stable, non-absorbent, durable and easy to clean. Ideal materials will be synthetic materials such as nylon, polyester (such as polyethylene terephthalate (PET) and polyethylene naphthalate (PEN)), and aramid fibers (such as Kevlar™), but natural materials such as flax (linen), hemp or cotton (including canvas), may also be used, and combinations of materials may be used, such as coated materials. The material may be knitted, sown or woven, or may be formed as a one-piece material such as by moulding or otherwise forming a mesh with one of the synthetic materials mentioned above.

In selecting a suitable flexible material, it is relevant to consider several material characteristics such as a material's modulus of elasticity, tensile strength (or tenacity), creep and flex loss. The material will ideally need to be capable of being held taut without tearing, regardless of the pressure of the spray hitting the curtain and regardless of wind conditions in which the apparatus may be operated. It will also need to be able to survive, for a reasonable period of time, potentially harsh weather conditions, and chemical erosion that may occur depending upon the chemicals being sprayed. In this respect, a polyvinyl chloride (PVC) coated PET polyester material has been found to be a useful material.

In selecting a suitable material, it is also relevant to consider the requirement for the front curtain to be pervious and the rear curtain to be impervious.

The pervious and flexible front curtain may be a mesh, gauze, web or netting, but will preferably be a mesh, all being in the form of a barrier of connected strands defining apertures therethrough. In the present invention, the strands are either of a flexible material, or are connected in a manner that renders the barrier flexible. Different materials have different strand thicknesses, widths and aperture sizes, with materials often being referenced by the size of the apertures. Suitable types of mesh include plain weave mesh, Dutch weave mesh, twilled weave mesh and others.

In relation to the principal role of the pervious front curtain, being to allow passage of air and spray droplets therethrough, into the overspray space, it will be appreciated that both thickness and width of the strands and the size of the apertures will affect that passage, again depending upon many factors such as the spray pressure, the liquid droplet size, the liquid type, and the contact angle of the spray with the curtain. Indeed, it is envisaged that thinner strand thicknesses combined with larger aperture sizes will be preferred in most situations, provided that the strength of the material is not unduly impacted, rather than simply adopting larger aperture sizes without regard to strand thickness (and thus adopting larger strand thicknesses in conjunction with the larger aperture sizes).

A suitable material need also not have constant or uniform aperture sizes and shapes, and so a suitable material may have a random arrangement of aperture sizes and shapes, or a patterned arrangement of aperture sizes and shapes. Additionally, a suitable material need not have a constant or uniform strand thickness or width, meaning that the material may have arrangements of thicker or thinner sections, or thicker or thinner strands, again either in a random or patterned arrangement. It is envisaged that thicker strand thicknesses and widths in some regions of an overspray collector may assist in improving the functioning of the overspray collector, either by minimising droplet bounce-back, maximising droplet collection, or assisting with the filtration function of the overspray collector.

In this respect, it is envisaged that a typical strand thickness will be in the range of from about 0.05 mm up to about 0.5 mm. In this form, the aperture size of the material of the pervious front curtain would be in the range of about 1.0 mm² to about 1.0 cm², and preferably in the range of about 1.0 mm² to about 25.0 mm².

Further in relation to the pervious front curtain, it must also be appreciated that the overspray collector of the apparatus of the present invention may include more than one pervious front curtain. Indeed, it is envisaged that two, three or four pervious front curtains may be adopted, either of the same material or of different material, and either with the same aperture and strand size and configuration, or with different sizes and configurations. It is also envisaged that an overspray space will be provided not only between the rearmost front curtain and the rear curtain, but also between each of the front curtains.

In relation to the impervious rear curtain, it will ideally not permit the passage therethrough of any air or liquid. However, it is envisaged that the rear curtain actually only need be impervious to liquids, and that the passage therethrough of some amount of air might be permissible and, in some situations, might be desirable.

In a preferred form of the present invention, in the overspray collector of the apparatus there would be a single pervious and flexible front curtain, and a single impervious and flexible rear curtain.

In relation to the overspray space, the space will preferably exist between every part of the front and rear curtains, but need not. Ideally this space will exist between the front and rear curtains at least adjacent to the entire area of the front curtain where the majority of the overspray hits the front curtain. In one form, the overspray space will exist between the front and rear curtains adjacent to the area of the front curtain where the overspray hits the front curtain, to an extent that is at least double the size of that area. In a more preferred form, the front and rear curtains will be substantially the same size and shape, and will be supported in a manner such that the overspray space exists between the entire surface area of both curtains, with the space being substantially constant therebetween.

The maximum distance between the front and rear curtains, being one relevant dimension of the overspray space, would ideally be in the broad range of from 10 mm to 1000 mm, more preferably in the range of 20 mm to 200 mm, and would ideally be about 40 mm to 100 mm. In this respect, this reference to a maximum distance would be a distance measured when the curtains are still and the apparatus is not operating. It will be appreciated that during operation, and particularly due to the preferred flexible nature of the curtains, the distance between the curtains will vary from time-to-time, and also is not likely to be a constant distance across the curtains.

Indeed, in one form of the present invention, and so as to avoid the overspray space becoming too small and ineffective, it is envisaged that a curtain separation device would be adopted so as to maintain a desired distance between the curtains (at preferred locations) during operation. Such a curtain separation device may simply be the inclusion of suitable battens or bows between the curtains, configured so as to maintain a desired curtain separation at desired locations throughout the overspray space, but not so as to unduly impede the passage of air and spray droplets through the front curtain, nor the passage of the collected spray down into the overspray chamber.

It should be appreciated that the front and rear curtains will ideally be sized so as to have a larger surface area than the surface area of the overspray at the point at which the overspray hits the front curtain, but need not be so sized. Indeed, there will likely be a portion, perhaps a large portion, of the front curtain that does not come into contact with (or at least direct contact with) the overspray, and there will likely be a portion of the overspray that does not come into contact with the front curtain. In practice, the front curtain will ideally be sized, shaped and positioned to come into contact with a majority of the overspray, and with as much of the overspray as practical engineering limitations allow with the overspray collector of the present invention, and as much as desired by the end user.

In this respect, the curtains may be of a square, rectangular, triangular, oval or circular shape (and indeed need not even each be of the same shape), provided that the curtain surface area is large enough to meet the above collection requirements. It will be appreciated that one of the benefits of the present invention is that it is possible to avoid the construction of a complete enclosure (like an enclosed tent or building) around the crop if such a complete enclosure is undesirable in any particular circumstance.

The overspray collector of the present invention functions in the presence of any suitable type of spray nozzle, that is located, in use, on the opposing side of a crop to the overspray collector. In practice that means that the overspray collector can be fitted to a wide range of existing spray apparatus as are currently commercially in use in crops like grape and hedgerow berry fruit production. While such spray apparatus might require re-positioning or adjusting to move or alter spray output patterns to maximise recapture potential, it will be appreciated that such existing spray apparatus will not require substantial reconfiguring in order to be adapted to use and benefit from the present invention.

In a preferred form, the mobile agricultural spray apparatus of the present invention includes a supporting frame for the spray nozzles and the overspray collector, the supporting frame being capable of arching over a row of crops such that at least one spray nozzle can be arranged to be on one side of the crop during spraying and the overspray collector can be arranged on the opposite side of the crop during spraying, and such that the overspray collector captures preferably at least a majority (and possibly substantially all) of the overspray from the spray nozzle. In this respect, it will be appreciated that the term “spray nozzle” here is being used in a broad sense to encompass any type of spray emitting device used to deliver spray droplets with or without air assistance to a target canopy, and that may or may not include sprays, nozzles, hoses and the like, whether fan or pressure assisted or not, and either provided singly or in multiples, and either provided as a series of aligned devices (such as a row of nozzles) or in any other grouping.

The supporting frame may be adapted to be mounted on a tractor or trailer or the like (self-propelled or separately driven or powered), the tractor or trailer including other equipment necessary for a mobile agricultural spray apparatus, such as tanks, pumps, control equipment, drive equipment and appropriate piping. In one form, two or more such supporting frames may be provided, so as to be able to spray two or more rows of crops. The supporting frame may be adapted so as to be foldable or adjustable as desired.

The supporting frame is preferably also capable of allowing for the overspray collector to itself be foldable, which is one of the advantages of using flexible curtains in the overspray collector. Indeed, when not in use, the supporting frame and the overspray collector may both then be folded quite compactly so as to permit easy storage and transport of the entire apparatus, and also to allow for ready access to tanks and the like on the apparatus.

Desirable foldability may be achieved by the use in the supporting frame of a foldable mounting member for the overspray collector. In one form, the foldable mounting member includes a lower boom that pivots upwardly from a base to lie parallel to a vertical dropper arm that supports the overspray collector.

In this respect, either the supporting frame or the foldable mounting member may also include an adjustment mechanism allowing for the alteration of the facing angle of the front curtain of the overspray collector from being substantially perpendicular to the spray direction (which is usually itself perpendicular to the direction of travel of the mobile agricultural spray apparatus), to being selectively placed at a desired angle to the spray direction. This may be useful where, for example, it is desired to re-direct some overspray back to the crop, and capture and collect remaining overspray for recycling. In this embodiment, the material and mesh-size selection (mentioned above) may be modified to permit a greater degree of bounce-back from the overspray collector than what might otherwise be regarded as acceptable where the aim is for complete capture and collection of all overspray.

The foldable mounting member also ideally includes a curtain mounting mechanism that allows for easy installation and replacement of the curtains thereon, and for placement of the curtains relative to each other in order to ensure the provision of a suitable overspray space therebetween, in terms of size and location, relative to the area of the overspray hitting the front curtain. A curtain mounting mechanism may be such that the curtains may be drawn along from a furled to an unfurled position (and vice-versa).

The foldable mounting member may also provide for mounting of, or the inclusion of, an overspray chamber, at or towards the bottom thereof, and at or towards the bottom of the flexible curtains, for collection of the spray liquid contained in the overspray, captured by the overspray collector as outlined above. This liquid may then be recycled to the spray nozzle of the apparatus, or may be collected for disposal or for dispensing by the apparatus in another manner.

An overspray chamber may simply be a gutter at the bottom of one or both of the flexible curtains, in one form created by the impervious rear curtain coming a short way up the lower face of the front curtain, and in another form formed by a u-shaped channel member located along the lower ends of the curtains to which the curtains are both affixed. Such a gutter may be inclined slightly downwardly to a collection point, such that captured overspray flows to the collection point via gravity, where it may pass through a filter and be pumped to a central collection tank. Such a central collection tank may also be gravity fed (or fed by a pump) and the collected overspray may be filtered prior to reintroduction to a main spray tank.

Finally, it will be appreciated that the mobile agricultural spray apparatus of the present invention is likely to have more than one spray nozzle and/or more than one overspray collector. Indeed, the apparatus is likely to include spray nozzles on both sides of a line of crops, with one or more opposing overspray collectors on the other side of the line of crops. To be clear, one overspray collector may function satisfactorily to collect overspray from two or more opposing spray nozzles, and the apparatus of the invention may effectively capture overspray from one, two or more crop rows that are treated in a single pass.

In the present invention, overspray projected through and beyond the canopy of a crop hits the pervious and flexible front curtain, allowing spray droplets to pass through the front curtain into the overspray space. In prior art systems, there is a lot of droplet bounce off impermeable and rigid surfaces, especially if they have been already wetted by spray liquid. Indeed, in many prior art systems, large droplets can be seen to break up on impact with such a surface and finer, potentially driftable, droplets are then released back into the air from the surface.

In contrast, the use of the pervious and flexible front curtain, and the impervious (and preferably flexible) rear curtain, in such a dual layer collection system, largely eliminates droplet release back into the air. Therefore, by matching a correct aperture size for the pervious front curtain, with the droplet size of the particular sprayers being used, amongst other factors as mentioned above, potential overspray recovery rates from impacted spray droplets can be maximised.

### BRIEF DESCRIPTION OF DRAWINGS

A preferred embodiment of a mobile agricultural spray apparatus in accordance with the present invention will now be described in relation to the accompanying drawings. However, it must be appreciated that the following description is not to limit the generality of the above description.

In the drawings:

FIG. 1 is a view from the rear of a mobile agricultural spray apparatus in accordance with the prior art, showing a typical spray region;

FIG. 2 is the same view as FIG. 1, but showing a mobile agricultural spray apparatus fitted with overspray collectors, and thus being in accordance with a preferred embodiment of the present invention, showing a modified spray region;

FIG. 3 is a perspective schematic view from the rear of the embodiment shown in FIG. 2;

FIG. 4a is the same view as FIG. 3 but showing an outer overspray collector retracted;

FIG. 4b is the same view as FIG. 4a but showing an inner overspray collector retracted; and

FIG. 5a is an exploded perspective view of the overspray collector shown in Box X of FIG. 4a; and

FIG. 5b is an end view of the overspray collector of FIG. 5a.

### DETAILED DESCRIPTION OF A PREFERRED EMBODIMENT

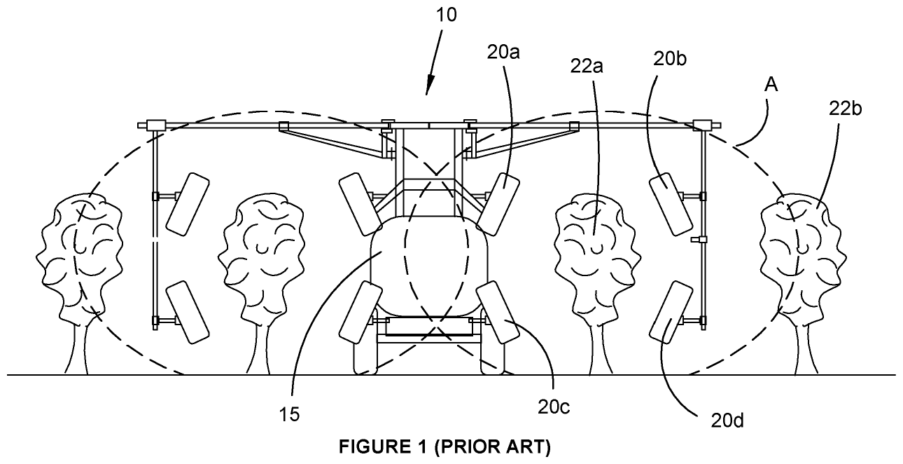

Illustrated in FIG. 1 is the view from the rear of a typical mobile agricultural spray apparatus 10. The apparatus 10 is in the form of a trailer designed to be towed by another vehicle (not shown). The mobile agricultural spray apparatus 10 includes a spray reservoir 15 for holding spray liquid and multiple spray nozzles in the form of fan assisted spray heads 20a, 20b, 20c etc for spraying liquid on rows of crop 22a, 22b etc. Other ancillary equipment and connections are also not shown, but their type and location will be understood by a skilled addressee. Also, only the parts of the apparatus on the right side of the illustration are provided with reference numerals—the same parts can, however, be seen on the left side of the illustration.

The two regions A in FIG. 1 are approximations of regions typically affected by the multiple spray heads 20a etc of the apparatus 10. As can be seen, the spray heads 20a etc generate spray excess to requirements, that is not caught by the crop canopies during spraying, which is then normally lost to the ground or to other surfaces. It is this overspray which the present invention seeks to address.

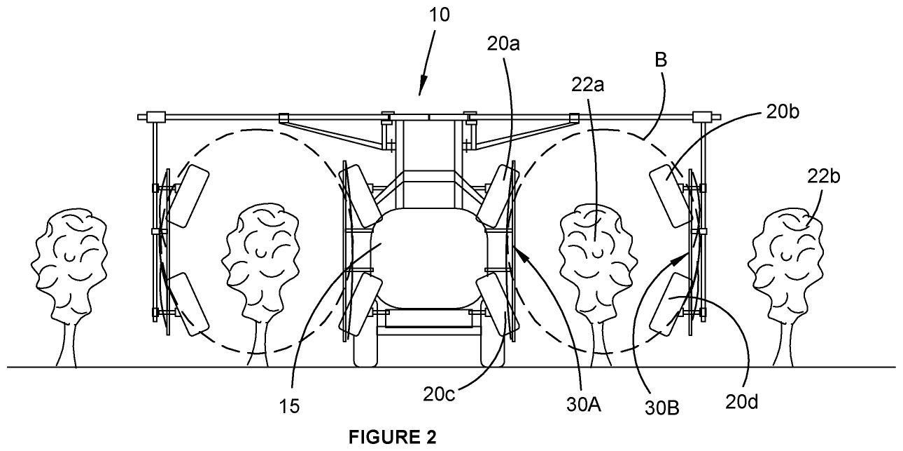

Illustrated in FIG. 2 is the same apparatus 10 fitted with overspray collectors 30a, 30b, where once again, only the overspray collectors on the right side of the illustration are provided with reference numerals. The region B is an approximation of the smaller region now affected by the multiple spray heads 20a etc once the overspray collectors 30a, 30b are in place and operational. Not only can the overspray collectors 30a,30b act to reduce the size of those regions, but they also act to collect overspray and return it to the spray reservoir 15 for reuse if desired.

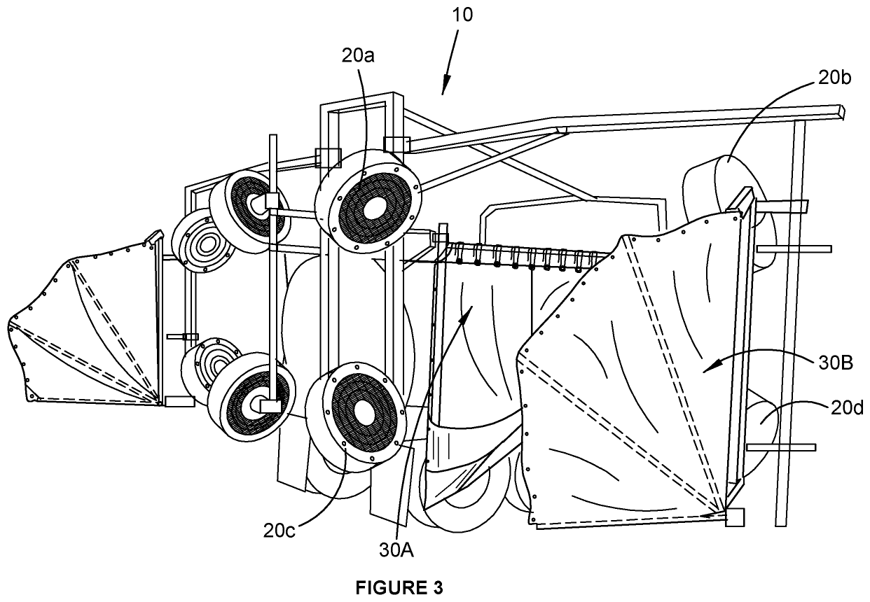

The arrangement of the overspray collectors 30a,30b is better illustrated in FIG. 3, without the crop rows shown. The outer overspray collector 30b is shown generally opposite the two inner spray heads 20a, 20c such that the overspray collector 30b can capture overspray from those two spray heads 20a, 20c during operation. The same is the case for the inner overspray collector 30a with respect to its location generally opposite the outer spray heads 20b, 20d and its ability to capture overspray from those spray heads. In this respect, it will be appreciated that all of the “spray nozzles” (being spray heads 20a etc) used in this embodiment are spray nozzles that include a fan mounted within a cowling, with multiple nozzles located about the periphery of the cowling such that spray is directed into the airflow to atomise and direct the spray liquid.

Of course, having said that, it will be appreciated that the type of spray nozzle used is not important with regard to the present invention—other types of spray nozzles may also be used with the apparatus of the invention.

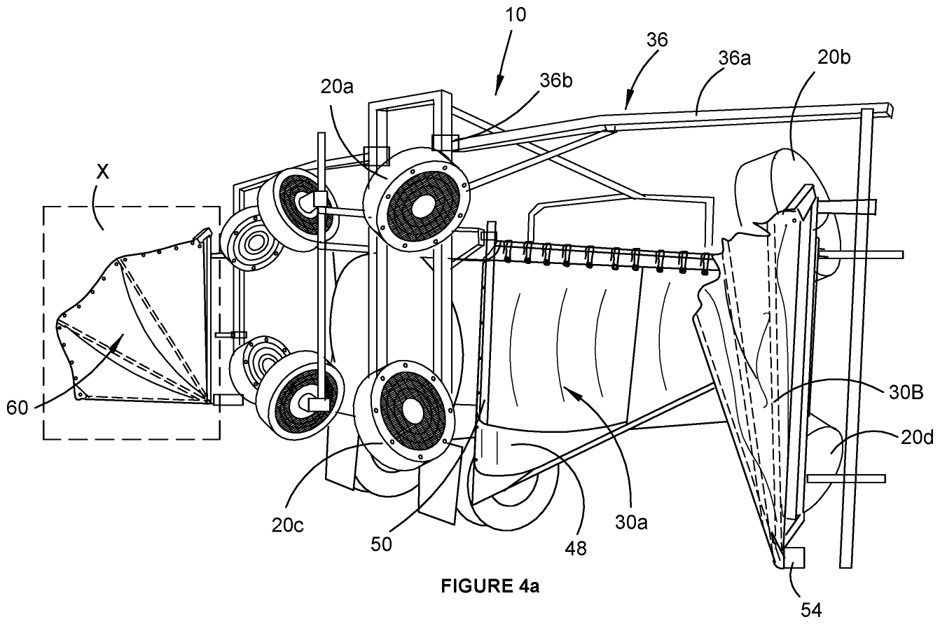

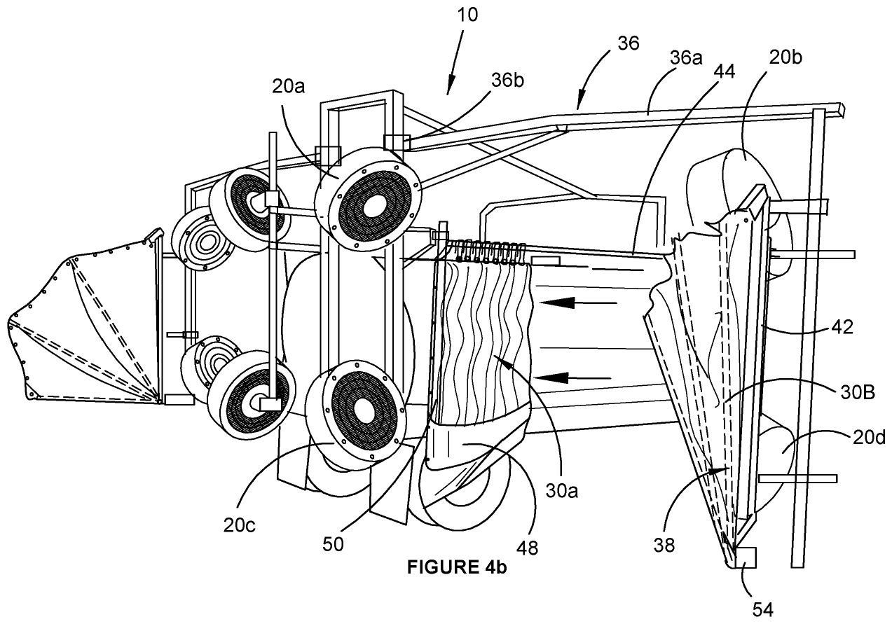

FIGS. 4a and 4b schematically illustrate the basic retraction and extension of the overspray collectors 30a,30b. Before describing them, it is to be appreciated that these actions, and how they are achieved in the apparatus of this embodiment, are not essential to the invention. Indeed, a skilled addressee will understand that the retraction and extension of the overspray collectors could be achieved in numerous ways.

The apparatus 10 shown in FIGS. 4a and 4b of the present invention includes a supporting frame 36 for the spray heads 20a, etc and the overspray collectors 30a,30b, the supporting frame 36 arching over a row of crops (not shown) such that the outer overspray collector 30b can be arranged to be on one side of a crop during spraying and the inner spray heads 20a,20c can be arranged on the other side of the crop during spraying, and such that the outer spray heads 20b,20d can also be arranged on the one side of the crop during spraying, with the inner overspray collector 30a also arranged to be on the other side of the crop during spraying. It can also be seen that this arrangement of opposing overspray collectors also functions to provide cross-wind protection for the crop spraying process, which can be quite advantageous in itself on days when cross-winds might otherwise hamper the crop spraying process.

The supporting frame 36 is adapted to be mounted on a tractor or trailer or the like (not generally shown), the tractor or trailer including other the ancillary equipment mentioned above (also not shown) necessary for a mobile agricultural spray apparatus, such as tanks, pumps, control equipment, drive equipment and appropriate piping.

The supporting frame 36 can be adapted so as to be foldable or adjustable as desired, such as by the incorporation of a suitable pivoting mechanism being provided at junction 36b so that arm 36a could be folded back upon the main apparatus, such as for the purpose of transport.

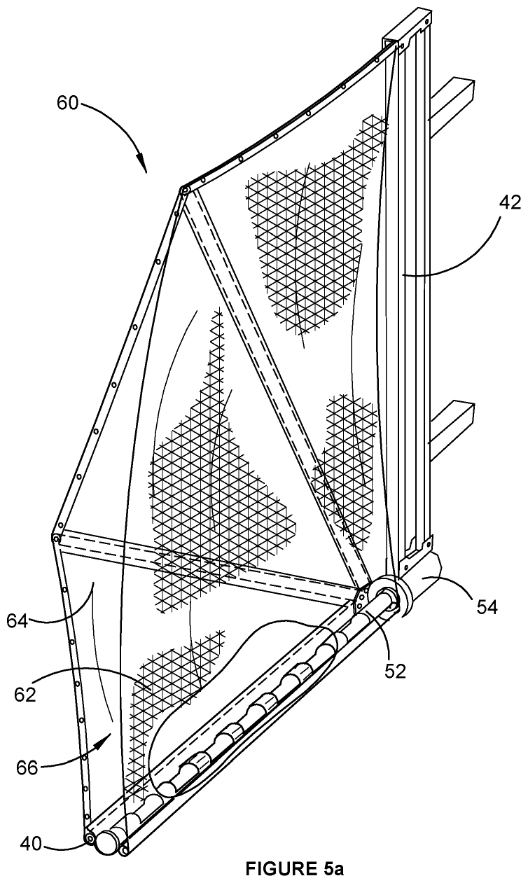

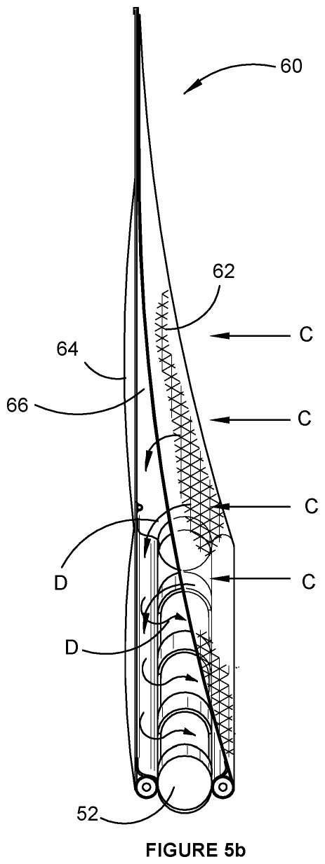

The supporting frame 36 also allows for each overspray collector 30a,30b to itself be foldable, such that, when not in use, the supporting frame 36 and the overspray collectors 30a,30b may all be folded compactly so as to permit easy storage and transport of the entire apparatus, and also to allow for ready access to tanks and the like on the apparatus. In this embodiment, desirable foldability is achieved by the use in the supporting frame 36 of foldable mounting members for the overspray collectors 30a,30b. A first foldable mounting member 38 includes a lower boom 40 that pivots upwardly from a base to lie parallel to a vertical dropper arm 42 that supports the overspray collector 30b. This first foldable mounting member is also evident in FIG. 5a.

A second foldable mounting member 44 includes a mounting mechanism that also allows for easy installation and replacement of the overspray collector 30a, and is such that the overspray collector 30a may be drawn therealong from a furled to an unfurled position (and vice-versa) as is evident in FIG. 4b.

In this embodiment, each foldable mounting member 38,44 also provides for the inclusion of an overspray chamber 48,52 for each overspray collector 30a,30b, at or towards the bottom thereof, for collection of the liquid contained in the overspray, captured by the overspray collector as outlined above (and as will become more evident below in describing FIGS. 5a and 5b). The overspray chamber 48 of the overspray collector 30a is a gutter at the bottom of the overspray collector 30a formed by the impervious rear curtain of the overspray collector 30a coming a short way up the lower face of the front curtain of the overspray collector 30a. A liquid removal tube 50 may be located in the lowermost portion of the overspray chamber 48, in association with a pump, to extract liquid therefrom that pools in the overspray chamber 48.

In this embodiment, the overspray chamber 52 of the overspray collector 30b (which is more evident in FIGS. 5a and 5b) is in the form of a U-shaped channel member located along the bottom of the overspray collector 30b to form a gutter. Such a gutter may be inclined slightly downwardly to a collection point 54, such that captured overspray flows to the collection point 54 via gravity, where it may pass through a filter and be pumped to a central collection tank (not shown). Such a central collection tank may also be gravity fed (or fed by a pump) and the collected overspray may be filtered prior to reintroduction to the main spray tank.

Turning now to a description of one preferred form of overspray collector, being the overspray collector 60 evident in box X in FIG. 4a, which is itself the same type of overspray collector as overspray collector 30b, the overspray collector 60 includes a front, pervious and flexible curtain 62 and a rear impervious curtain 64. There is an overspray space 66 between the pervious front curtain 62 and the impervious rear curtain 64, and there is an overspray chamber 52 in fluid communication with the overspray space 66 for collection of overspray captured by the overspray collector 60.

The curtains 62,64 of the overspray collector 60, in conjunction with the overspray space 66, function in combination to dampen the pressure and speed (and thus the energy) of the droplets of the overspray (entering at arrows C in FIG. 5b), minimising or entirely reducing spray bounce-back and/or spray droplet shatter from the overspray collector 60, and to maximise the capture of overspray that reaches the collector 52. As mentioned above, the pervious nature of the front curtain 62 permits the passage of both air and liquid droplets (and small solid particles if the spray includes solid particles) through the front curtain 62 into the overspray space 66, but yet minimise the return of air and liquid droplets back through the front curtain after impacting the impervious rear curtain and circulating within the overspray space 66, as shown by arrows D in FIG. 5b.

In this embodiment, both of the curtains 62,64 are formed from a polyester material (PET), with the front curtain 62 being a PVC coated PET material formed as a plain weave mesh with a strand thickness of about 0.28 mm and an aperture size of about 2.0 mm².

In relation to the overspray space 66, the space is shown in FIG. 5b existing between almost every part of the front and rear curtains 62,64, but for the upper reaches of those curtains. Ideally this space will exist between the front and rear curtains at least adjacent to the entire area of the front curtain 62 where the majority of the overspray hits the front curtain 62.

As also mentioned above, the maximum distance between the front and rear curtains 62,64, would ideally be in the broad range of from 10 mm to 1000 mm, more preferably in the range of 20 mm to 200 mm, and would ideally be about 40 mm to 100 mm. This reference to a maximum distance would be a distance measured when the curtains are still and the apparatus is not operating, and preferably would be constant across at least a portion of the curtains. However, with the illustrated construction of the preferred embodiment, it can be seen that the distance varies from a maximum at the bottom of the curtains to a minimum at the top of the curtains. In this embodiment, it is envisaged that at least the lower half of the space 66 has a distance between the curtains in the above preferred range of 20 mm to 200 mm. Of course, it will also be appreciated that during operation, and particularly due to the preferred flexible nature of the curtains, the distance between the curtains will vary from time-to-time.

Finally, those skilled in the art will appreciate that the invention described herein is susceptible to variations and modifications other than those specifically described. It is to be understood that the invention includes all such variations and modifications.

1. A mobile agricultural spray apparatus, the spray apparatus including at least one spray nozzle arranged to be on one side of a crop during spraying and an overspray collector arranged to be on the opposite side of the crop during spraying such that the overspray collector can capture overspray from the spray nozzle during operation, wherein the overspray collector includes:
at least two curtains, the curtains including at least one pervious and flexible front curtain and an impervious rear curtain;
an overspray space between the pervious front curtain and the impervious rear curtain; and
an overspray chamber in fluid communication with at least the overspray space for collection of the overspray captured by the overspray collector.

2. Apparatus according to claim 1, wherein the rear curtain is also a flexible curtain.

3. Apparatus according to claim 1, wherein the flexible curtains function in combination with the overspray space to dampen the energy of droplets in the overspray, minimising spray bounce-back and/or spray droplet shatter from the overspray collector, and to maximise the capture of overspray that reaches the collector.

4. Apparatus according to claim 1, wherein the front curtain permits the passage of both air and spray droplets into the overspray space, but minimises the return of air and spray droplets back through the front curtain after impacting the impervious rear curtain and circulating within the overspray space.

5. Apparatus according to claim 1, wherein liquid from the overspray is captured on each of the outside and inside surfaces of the front curtain, the inside surface of the rear curtain, and within the overspray space, with captured liquid falling or flowing by way of gravity downwardly to be collected by the overspray chamber of the overspray collector.

6. Apparatus according to claim 1, wherein the flexible curtains are formed from a non-rigid material that is pliant and supple.

7. Apparatus according to claim 6, wherein the flexible curtains are formed from a natural material such as flax (linen), hemp or cotton (including canvas), or a synthetic material such as nylon, polyester (such as polyethylene terephthalate (PET) and polyethylene naphthalate (PEN)), and aramid fibers.

8. Apparatus according to claim 1, wherein the pervious and flexible front curtain is a barrier of connected strands defining apertures therethrough, the aperture size being in the range of about 1.0 mm² to about 1.0 cm².

9. Apparatus according to claim 8, wherein the overspray collector includes more than one pervious front curtain, either of the same material or of different material, and either with the same aperture size or with a different aperture size.

10. Apparatus according to claim 1, wherein the overspray space between the front and rear curtains has a maximum distance in the range of from 10 mm to 1000 mm, more preferably in the range of 20 mm to 200 mm, and ideally in the range of 40 mm to 100 mm.

11. Apparatus according to claim 10, the apparatus including a curtain separation device capable of maintaining a desired distance between the curtains during operation.

12. Apparatus according to claim 1 wherein the overspray space exists between every adjacent part of the front and rear curtains, or only exists between the front and rear curtains adjacent to the entire area of the front curtain where the overspray hits the front curtain.

13. Apparatus according to claim 1, wherein the front and rear curtains are substantially the same size and shape, and are supported in a manner such that the overspray space exists between the entire surface area of both curtains.

14. Apparatus according to claim 1, including a supporting frame for the spray nozzle and the overspray collector, the supporting frame being capable of arching over a row of crops such that at least one spray nozzle can be arranged to be on one side of the crop during spraying and the overspray collector can be arranged on the opposite side of the crop during spraying, and such that the overspray collector captures overspray from the spray nozzle.

15. Apparatus according to claim 14, wherein the supporting frame is capable of allowing for the overspray collector to be foldable.

16. Apparatus according to claim 15, wherein foldability is provided by the use in the supporting frame of a foldable mounting member for the overspray collector.

17. Apparatus according to claim 16, wherein either the supporting frame or the foldable mounting member also include an adjustment mechanism allowing for the alteration of the facing angle of the front curtain of the overspray collector from being substantially perpendicular to the spray direction, to being selectively placed at a desired angle to the spray direction.

18. Apparatus according to claim 17, wherein the foldable mounting member includes a curtain mounting mechanism.

19. Apparatus according to claim 16, wherein the foldable mounting member provides for mounting of an overspray chamber, at or towards the bottom thereof, and at or towards the bottom of the flexible curtains, for collection of the spray liquid contained in the overspray, captured by the overspray collector.

20. Apparatus according to claim 1, including more than one spray nozzle and/or more than one overspray collector.
